(19) United States
(12) Patent Application Publication
(10) Pub. No.: US 2021/0178823 A1
(43) Pub. Date: Jun. 17, 2021

(54) TRUCK TIRE

(71) Applicant: The Goodyear Tire & Rubber Company, Akron, OH (US)

(72) Inventors: Ettore Passante Spaccapietra, Ettelbruck (LU); Philippe Joseph Auguste Muller, Champlon (BE); Didier Winkin, Bastogne (BE); Marco Nicolò Coccon, Luxembourg Ville (LU); Arun Prasath Manogaran, Everlange (LU); Roland Willibrord Krier, Wasserbillig (LU); Vaibhav Nawale, Boevange-sur-Attert (LU)

(21) Appl. No.: 17/070,209

(22) Filed: Oct. 14, 2020

Related U.S. Application Data
(60) Provisional application No. 62/949,010, filed on Dec. 17, 2019.

(51) Int. Cl. B60C 9/28; B60C 9/20

(52) U.S. Cl. CPC B60C 9/28; B60C 9/2006; B60C 2200/06; B60C 2009/2019; B60C 2009/2016

(57) ABSTRACT

A pneumatic tire for use on trucks, the tire comprising: a tread which includes a belt reinforcement structure of only three belts, the belt structure including a pair of working belts, wherein the angle of the working belts range from about 12 degrees to about 35 degrees, wherein a low angle belt is positioned preferably between of the working belts, wherein the angle of the low angle belt is less than 5 degrees. The working belts are made of high elongation wire having an elongation at break greater than 3.5%.

### FIELD OF THE INVENTION

The invention relates in general to pneumatic tires, and more particularly for vehicles such as trucks.

### BACKGROUND OF THE INVENTION

The commercial truck market is moving towards an increase in overall vehicle weight, which is due in part to the increase in weight of the motor and equipment. The increase in overall vehicle weight requires a tire capable of handling the additional loading. Thus, a tire with improved crown durability and increased load carrying capacity is desired.

### SUMMARY OF THE INVENTION

The invention provides in a first aspect a pneumatic tire for use on trucks, the tire having a tread, sidewalls, and a pair of beads, and a belt reinforcement structure located radially inward of the tread, the belt structure consisting essentially of only three belts, wherein two of the belts are a pair of working belts, wherein the angle of the working belts range from about 12 degrees to about 35 degrees from the circumferential direction, wherein the working belts are extensible, wherein the third belt is a low angle belt having reinforcements angled at less than 5 degrees located between the working belts.

The invention provides in a second aspect a pneumatic tire for use on trucks, the tire having a tread, sidewalls, and a pair of beads, and a belt reinforcement structure located radially inward of the tread, the belt structure has only three belts, wherein two of the belts are a pair of working belts, wherein the angle of the working belts range from about 12 degrees to about 35 degrees from the circumferential direction, wherein the working belts are extensible, wherein the third belt is a low angle belt having reinforcements angled at less than 5 degrees located between the working belts.

### Definitions

“Aspect Ratio” means the ratio of a tire's section height to its section width.

“Axial” and “axially” mean the lines or directions that are parallel to the axis of rotation of the tire.

“Bead” or “Bead Core” mean generally that part of the tire comprising an annular tensile member, the radially inner beads are associated with holding the tire to the rim being wrapped by ply cords and shaped, with or without other reinforcement elements such as flippers, chippers, apexes or fillers, toe guards and chafers.

“Belt Structure” or “Reinforcing Belts” means at least two annular layers or plies of parallel cords, woven or unwoven, underlying the tread, unanchored to the bead, and having both left and right cord angles in the range from 17° to 27° with respect to the equatorial plane of the tire.

“Bias Ply Tire” means that the reinforcing cords in the carcass ply extend diagonally across the tire from bead-to-bead at about 25-65° angle with respect to the equatorial plane of the tire, the ply cords running at opposite angles in alternate layers

“Block element” means a tread element defined by a circumferential groove or shoulder and a pair of laterally extending grooves.

“Breakers” or “Tire Breakers” means the same as belt or belt structure or reinforcement belts.

“Carcass” means a laminate of tire ply material and other tire components cut to length suitable for splicing, or already spliced, into a cylindrical or toroidal shape. Additional components may be added to the carcass prior to its being vulcanized to create the molded tire.

“Circumferential” means lines or directions perpendicular to the axial direction within + or −5 degrees.

“Cord” means one of the reinforcement strands, including fibers, which are used to reinforce the plies.

“Extensible” means a cable having a relative elongation at break of greater than 0.2% at 10% of the breaking load, when measured from a cord extracted from a cured tire.

“Inner Liner” means the layer or layers of elastomer or other material that form the inside surface of a tubeless tire and that contain the inflating fluid within the tire.

“Inserts” means the reinforcement typically used to reinforce the side edges of runflat-type tires; it also refers to the elastomeric insert that underlies the tread.

“Ply” means a cord-reinforced layer of elastomer-coated, radially deployed or otherwise parallel cords.

“Radial” and “radially” mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Rib” means a circumferentially extending strip of rubber of the tread which is defined by at least one circumferential groove and either a second circumferential groove or a lateral edge, wherein the strip is not divided by full depth grooves.

“Radial Ply Tire” means a belted or circumferentially-restricted pneumatic tire in which the ply cords which extend from bead to bead are laid at cord angles between 65° and 90° with respect to the equatorial plane of the tire.

“Side edge” means a portion of a tire between the tread and the bead.

“Sipe” means small slots or elongated void areas typically formed by thin steel blades, and which tend to remain closed, and function to increase traction.

“Laminate structure” means an unvulcanized structure made of one or more layers of tire or elastomer components such as the innerliner, side edges, and optional ply layer.

### BRIEF DESCRIPTION OF THE DRAWINGS

The invention will be described by way of example and with reference to the accompanying drawings in which:

FIG. 1 is a cross-sectional view of a first embodiment of a tire of the present invention; and

FIG. 2 is a close-up view of the belt package of the tire of FIG. 1.

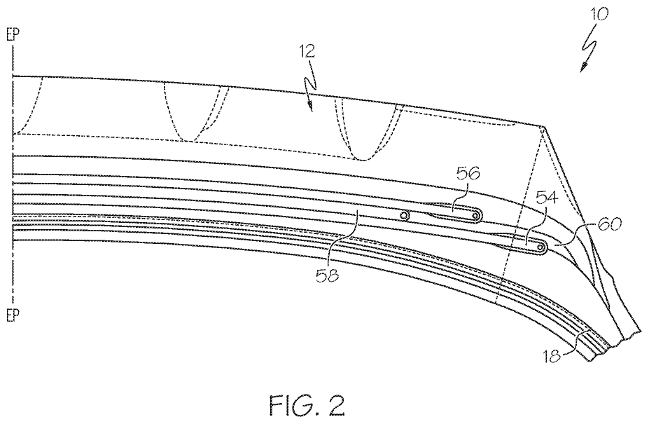

### DETAILED DESCRIPTION OF THE INVENTION

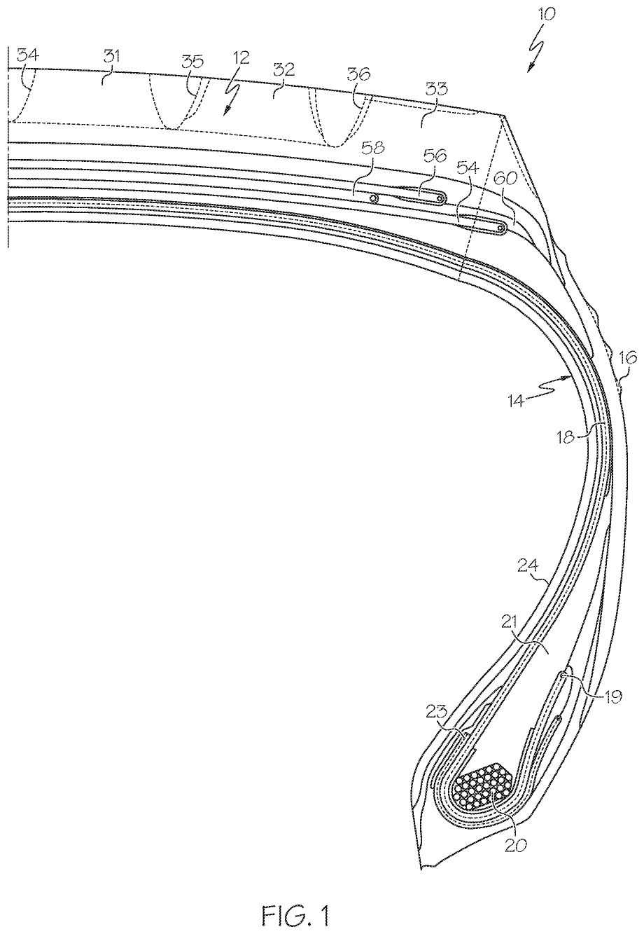

FIG. 1 illustrates a first embodiment of a pneumatic tire, suitable for use as a truck tire. The tire 10 has a tread 12 with a non-skid depth D. The tire tread 12 may comprise a plurality of circumferentially continuous ribs, which may vary, but are shown for example as ribs 31, 32 and 33. Positioned between each rib is a circumferential groove 34, 35, 36, which are preferably continuous. The tread may also comprise optional sipes (not shown). The tread pattern is not limited to same, and may comprise, for example, a plurality of blocks and grooves (not shown).

The tire 10 further comprises a casing 14 which includes two opposed sidewalls 16 which extend down from the tread 12 to the bead area. The casing of the tire may optionally include an inner liner 24 which is typically formed of halobutyl rubber which forms an air impervious barrier. The tire casing 14 further includes one or more radial plies 18 extending from the tread, down the sidewall to the tire bead 20. Preferably the radial ply 18 is wrapped about or otherwise secured to each annular bead 20. In the embodiment illustrated and not limited to same, there is only one ply 18 and it is wrapped around the bead in an inside out manner such that the ply ending 19 is located axially outward and radially outwards of the bead. The beads 20 may be any desired shape, but in this embodiment, it is shown as a hexagonal configuration with steel filaments.

The tire may further optionally include an apex 21 which may be shaped like a triangle. The ply turnup in the bead area may be optionally reinforced with a chipper 23 wrapped about the bead ply 18.

The tire 10 further includes a belt package 50 which is located between the tread and the one or more plies 18. The belt package may be comprised of only three belt layers of reinforcement. The ply 18 and the belt reinforcing structure 50 are made from cord reinforced elastomeric material, wherein the cords are typically steel wire or polyamide filaments and the elastomer preferably being rubber.

The belt reinforcing package 50 is limited to only three belts, and includes a pair of extensible working belts, 54, 56. Belt 54 is located radially inwards of belt 56. Belt 54 has a width which is about equal to the tread arc width. Preferably, belt 54 has a belt width substantially equal to the tread arc width. The breaker angle of belt 54 is between about 12 and 35 degrees, preferably with a right orientation, more preferably in the range of about 19 to about 25 degrees. Belt 54 is preferably made of high elongation wire, which is defined as being dipped in RFL and has a % elongation at 10% of the breaking load of greater than 0.4%, as measured from a cord taken from a cured tire. Alternatively, the cable has a % elongation at 10% of breaking load of greater than 1.7% when measurement is performed on a bare wire sample that has not been vulcanized in a tire. For example, the belt may be formed of wire having a wire construction of 3×7×, 3×4×, 4×4×. Preferably the wire has a construction of 3×7×0.22 HE. The EPI may range from about 8 to about 14.

Belt 56 is the second member of the working belt pair. Belt 56 has a width less than the width of belt 54 (the other working belt), and is preferably radially outward of belt 54. Preferably, the belt 56 has a width less than the width of belt 54 by a step off, which may range from about 10 to about 20 mm. Belt 56 has a breaker angle between about 12 and 35 degrees, preferably with a left orientation, more preferably in the range of about 19 to about 25 degrees. Belt 56 is preferably made of high elongation wire, having the same construction with the same but opposite angular orientation as belt 54.

The belt structure 50 further comprises a third belt 58 which is preferably located between the working pair belts, 54, 56. The third belt 58 may also be located between belts 52 and 54 or radially outward of belt 56. The third belt 58 has reinforcements that are oriented circumferentially at 5 degrees or less, preferably 0 degrees. The belt is preferably formed from spirally winding a rubberized strip of two or more cords. Preferably the strip has about 7 steel cords. Alternatively, the belt may be formed of a cut belt with the reinforcements oriented in the range of 0 to about 10 degrees from the circumferential direction. The third belt 58 has a width sized to avoid compression in the shoulder area. The belt width of the third belt 58 is preferably in the range of about 70% to about 80% of the tread arc width, and even more preferably in the range of 73-77%. The third belt 58 is wide enough to decrease the strain cycles in the breaker wedge, and is just stopped before the shoulder area to avoid 0 degree wire compression and a too round footprint. The belt structure of belt 48 may be steel formed of 4+3×0.35 construction or aramid.

The belt structure excludes an overlay belt or a transition belt, or any additional belts, and is limited to only the three belts described above.

The aspect ratio of the tire described above may vary. The aspect ratio is preferably in the range of about 50 to about 90. The tire may have a net to gross ratio in the range of about 70 to about 90, more preferably in the ratio of about 74 to about 86, more preferably about 78 to 84.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A pneumatic tire for use on trucks, the tire having a tread, sidewalls, and a pair of beads, and a belt reinforcement structure located radially inward of the tread, the belt structure consisting essentially of only three belts, wherein two of the belts are a pair of working belts, wherein the angle of the working belts range from about 12 degrees to about 35 degrees from the circumferential direction, wherein the working belts are extensible, wherein the third belt is a low angle belt having reinforcements angled at less than 5 degrees located between the working belts.

2. The tire of claim 1 wherein the radially inner working belt has a width about equal to the tread arc width.

3. The tire of claim 1 wherein the radially outer working belt has a width less than the radially inner working belt.

4. The tire of claim 1 wherein the radially inner working belt is the widest belt of the belt reinforcement structure.

5. The tire of claim 1 wherein the low angle belt has a width in the range of about 70 to about 80 percent of the tread arc width.

6. The tire of claim 1 wherein the aspect ratio of the tire is less than or equal to about 0.6.

7. A pneumatic tire for use on trucks, the tire having a tread, sidewalls, and a pair of beads, and a belt reinforcement structure located radially inward of the tread, the belt structure has only three belts, wherein two of the belts are a pair of working belts, wherein the angle of the working belts range from about 12 degrees to about 35 degrees from the circumferential direction, wherein the working belts are extensible, wherein the third belt is a low angle belt having reinforcements angled at less than 5 degrees located between the working belts.
